(19) United States
(12) Patent Application Publication
(10) Pub. No.: US 2024/0029024 A1
(43) Pub. Date: Jan. 25, 2024

(54) ELECTRONIC CALENDAR SYSTEM, METHOD AND COMPUTER PROGRAM PRODUCT THEREOF

(71) Applicant: NETRONIX, INC., JUBEI CITY (TW)

(72) Inventors: LING LING WU, JUBEI CITY (TW); LI FANG FAN, JUBEI CITY (TW); YA XIN FAN, JUBEI CITY (TW); HSING YEN LAI, JUBEI CITY (TW); I YING LIN, JUBEI CITY (TW); JUNG KUANG TSAI, JUBEI CITY (TW); LI YI, JUBEI CITY (TW)

(21) Appl. No.: 17/932,927

(22) Filed: Sep. 16, 2022

(30) Foreign Application Priority Data
Jul. 19, 2022 (TW) 111127003

(51) Int. Cl. G06Q 10/10

(52) U.S. Cl. CPC G06Q 10/1093

(57) ABSTRACT

The invention relates to an electronic calendar system method, and computer program product thereof. The system includes a cloud platform, at least one user terminal, at least one creative terminal, and a display terminal. The cloud platform is connected to the user terminal and the creative terminal, and the user terminal is connected to the display terminal. The creative terminal provides the digital creative content to transmit to the cloud platform. The user terminal obtains at least one digital calendar template and digital creative content front the cloud platform. The user terminal combines the digital calendar template, the digital creative content, and the digital calendar schedule to generate a graphical digital calendar, and transmits the graphical digital calendar to the display terminal by the user the terminal. The display terminal outputs the graphical digital calendar.

This application claims priority of Application No. 111127003 filed in Taiwan on 19 Jul. 2022 under 35 U.S.C. § 119 the entire contents of all of which are hereby incorporated by reference.

### BACKGROUND OF THE INVENTION

### Field of the Invention

The invention relates to a calendar, especially an electronic calendar system that uses an application program of an intelligent electronic device to combine the image data and text data of the digital calendar with the template to form the digital calendar data that can be transmitted to the electronic calendar device, and method and computer program product thereof

### Description of the Prior Art

The traditional paper calendar notepad (hereinafter referred to the calendar notepad) is an important tool for people to record and plan the matters to be dealt with every day or in the future. The content that the calendar notepad can record is limited by the paper layout size and only limited to the use of handwritten text, symbols, or hand-painted patterns. However, some people have designed some seals to carve commonly used words or patterns to achieve the purpose of shorthand.

However, instead of such a recording method, applications of the electronic calendar (hereinafter referred to as the digital calendar) installed in intelligent electronic devices (such as mobile phones, computers, and smartwatches) have been widely used in this era of booming information and rapid technological change. The digital calendar can be used for recording personal/work matters and planning private/work/trip schedules, etc. The digital calendar can be Google Calendar, Calendar (the built-in application of iPhone). Microsoft Calendars in Outlook, etc. The digital calendar can perform with URLs, electronic maps, various applications, etc. For example, when the digital calendar is presented in the form of months, the digital calendar represents grids arranged in an array in order of date and week of the month. The grids can be used for recording various events and, arranging journeys as in a traditional calendar notepad, and can be switched between days, weeks, months, and years. Digital calendars provide the user with various ways to record events and journeys, and the grids represent the digital calendar in multiple appearances. Besides, digital calendars can be shared and co-edited. with others, no longer limited to personal use.

However, only a default layout can be represented in the digital calendar, and the appearance of the default layout is too monotonous. Currently there is no digital calendar template selectable for users, and neither electronic photos nor electronic patterns can be directly added to the digital calendar, so it is difficult to achieve the purpose of beautifying the digital calendar. In addition, since the user cannot directly view the digital calendar, the user has to open the application thereof to see the content recorded therein. Therefore, it is necessary to improve the problems.

### SUMMARY OF THE INVENTION

In view of the abovementioned problems, one of the purposes of the invention is that utilizing an intelligent electronic device to generate a graphical digital calendar by combining a digital creative content with the digital calendar, to convert the graphical digital calendar into data for electronic transmission, and to enable an electronic display device directly display the graphical digital calendar according to the data without tedious operation steps.

According to the purpose of the invention, an electronic calendar system is provided. The electronic calendar system comprises a cloud platform, at least one user terminal, at least one creative terminal, and at least one display terminal. The cloud platform connects with the user terminal or the creative terminal according to the request there the same. The creative terminal transmits the digital creative content and the digital calendar template made by the creator to the cloud platform. When the user terminal is connected to the cloud platform, the user terminal can obtain the at least one digital calendar template and the at least one digital creation uploaded by the creative terminal from the cloud platform. Then, the user terminal combines the digital calendar template, the digital creative content, and a digital calendar schedule to generate a graphical digital calendar. Also, the user terminal connects to the display terminal and transmits the graphical digital calendar to the display terminal for outputting the graphical digital calendar.

In an embodiment, the user terminal has a configuration application module including an image and data management unit, a template setting management unit, a connection unit, and a transmission unit. The template setting management unit combines the digital creative content with the digital calendar schedule in the digital calendar template, thereby generating the display description data of the graphical digital calendar. The image and data management unit Obtains the digital calendar template, the digital creative content, and the digital calendar schedule, and stores the display description data. The image and data management unit generates the graphical digital calendar according to the display description data. The connection unit connects with the display terminal. When the user terminal and the display terminal are connected, the transmission unit transmits the graphical digital calendar to the display terminal for outputting the graphical digital calendar.

In an embodiment, the user terminal is an intelligent electronic device, the configuration application module is an application program, and the configuration application module has a graphical interface to provide a presentation of the image and data management unit, the template setting management unit, the connection unit, and the transmission unit. The presentation shows the operation of inputting software objects.

In an embodiment, when the user terminal is connected with the display terminal for the first time, the user terminal pairs and connects with the display terminal through the connection unit, obtains a device serial number and a power information of the display terminal, records a current geographic location information, and after the graphical electronic calendar is transmitted, disconnects from the display terminal.

In an embodiment, the user terminal includes a background execution unit and a detection unit. The background execution unit controls the image and data management unit to generate a new graphical digital calendar according to the display description data when an update event occurs. When the detection unit detects that the display terminal is in a connectable range and state, the detection unit activates the connection unit to establish a connection between the user terminal and the display terminal and then transmits the new graphical digital calendar to the display terminal.

In an embodiment, when the detection unit detects that the display terminal is in the connectable range and state, the detection unit detects a current geographic location information of the user terminal and generates a position distance information by comparing a previously recorded geographic location information and the current geographic location information. At the same time, the detection unit performs a broadcast detection to search the display terminal. When the position distance information is less than a preset distance threshold of the detection unit, the detection unit increases a frequency of broadcast detection and reduces a frequency of detecting and comparing the current geographic location information of the user terminal. When the detection unit detects the display terminal, the detection unit analyzes a signal strength between the user terminal and the display terminal. When the signal strength is greater than a preset intensity threshold of the detection unit, the detection unit makes the connection unit connect with the display terminal, and then transmits the new graphical digital calendar to the display terminal.

According to the purpose of the invention, a method for generating a digital calendar is provided. The method is applied to a user terminal having a configuration application module. The configuration application module comprises an image and data management unit, a template setting management unit, a connection unit, and a transmission unit. The method comprises the following steps: obtaining a digital calendar template, a digital creative content, and a digital calendar schedule from a cloud platform by the image and data management unit; by the template setting management unit, setting a type of the digital creative content and the digital calendar schedule combined in the digital calendar template to generate a display description data of a graphical digital calendar, and storing the display description data in the image and data management unit; and establishing a connection between the user terminal and the display terminal by the connection unit, and when the user terminal is connected with the display terminal, transmitting the graphical electronic calendar to the display terminal by the transmission unit, wherein the graphical electronic calendar is generated by the image and data management unit according to the display description data.

In an embodiment, the step of obtaining the digital calendar schedule includes using the login it information recorded by the user terminal through the application program interface to log into a remote server for the digital calendar and then obtaining the digital calendar schedule.

In an embodiment, the step of obtaining the digital creative content and the digital calendar template is using a web application programming interface to connect to the cloud platform, and then obtaining the digital creative content and digital calendar template purchased by the user terminal from the cloud platform.

In an embodiment, when the user terminal is connected with the display terminal for the first time, the method further comprises steps: paring and establishing the connection between the user terminal and the display terminal by the connection unit; after the user terminal is connected with the display terminal, obtaining a device serial number and a power information of the display terminal by the user terminal; and disconnecting the connection between the user terminal and the display terminal after the graphical digital calendar is transmitted.

According to the purpose of the invention, a computer program product for generating a digital calendar is provided to execute the aforementioned method after loading the computer program product through an intelligent electronic device.

In summary, the user terminal uses the application program to combine the digital calendar template and digital creative content of the cloud platform, thereby generating a graphical digital calendar, and further transmits the graphical digital calendar to the display terminal. The invention solves the problem that the traditional digital calendar cannot be beautified and the problem that the contents of the digital calendar cannot be directly viewed.

### BRIEF DESCRIPTION OF THE DRAWINGS

FIG. 1 is an architectural diagram of the system of the invention.

FIG. 2 is a schematic diagram of the user interface of the user terminal.

FIG. 3 is an architectural diagram of the user terminal.

FIG. 4A to 4D are schematic diagrams of setting different graphical electronic calendars on the user interface of the user terminal.

FIG. 5 is a schematic flowchart of a method fir generating a digital calendar according to the invention.

FIG. 6 is a schematic flowchart of the first connection between the user terminal and the display terminal according to the invention.

FIG. 7 is a schematic flowchart of generating the display description data by the template setting management unit of the invention.

FIG. 8 is a schematic flowchart of an updated event occurring in the invention.

FIG. 9 is a schematic flowchart of the detection unit of the invention confirming that the display terminal is in the connectable range.

### DESCRIPTION OF THE PREFERRED EMBODIMENTS

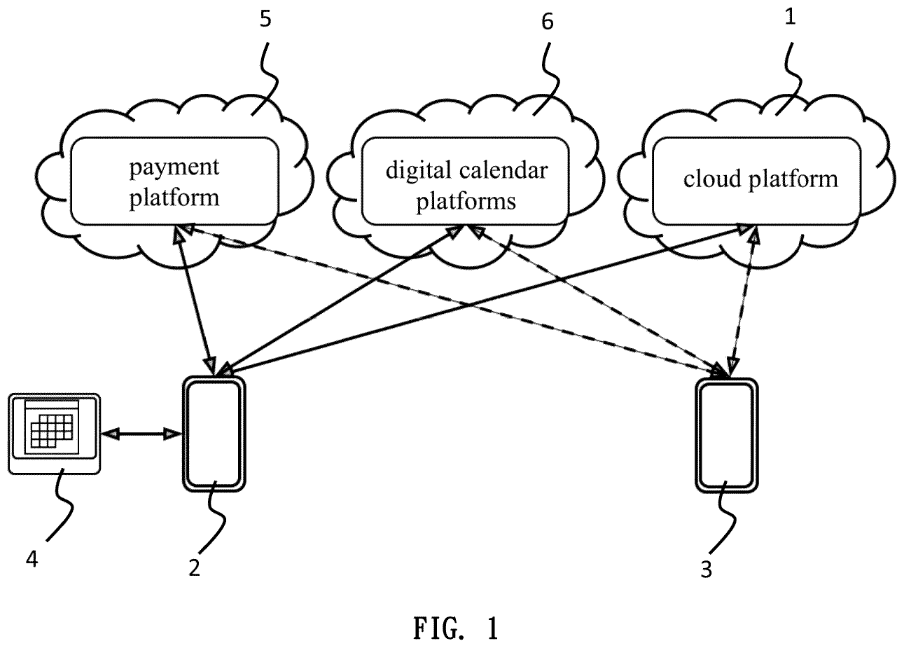

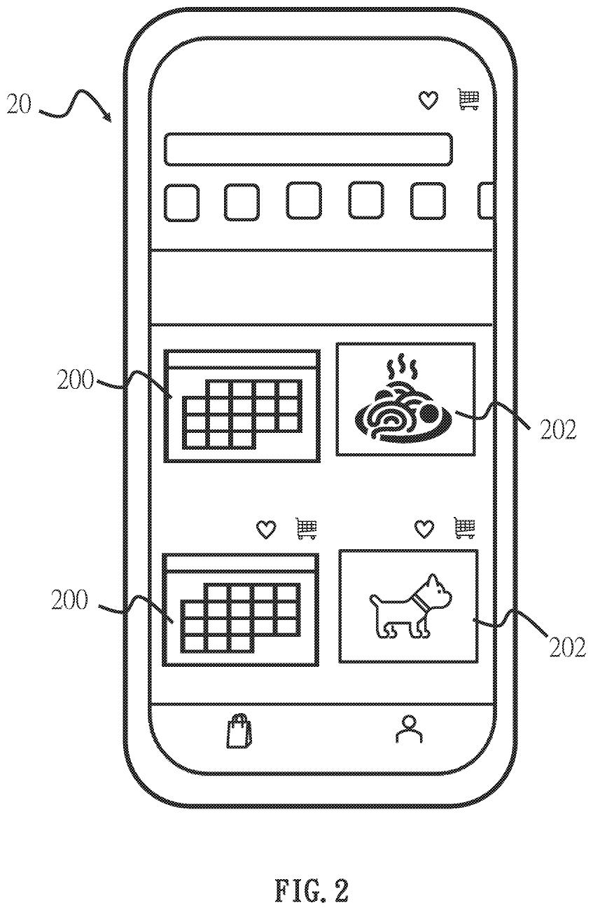

Please refer to FIG. 1, the invention is an electronic calendar system, including a cloud platform 1, least one user terminal 2, at least one creative terminal 3, and at least one display terminal 4, wherein the cloud platform 1 is the data center hardware for computing execution. The cloud platform includes at least the server, the storage device, and the network connection, and provides the user interface of the application program used by each user terminal 2 and creative terminal 3. The user terminal 2 and the creative terminal 3 are intelligent electronic devices, such as smart mobile phones, tablet computers, notebook computers, desktop computers, etc. The difference between the user terminal 2 and the creative terminal 3 is that user terminal 2 is an intelligent electronic device operated b the consumer. The intelligent electronic device receives the consumer's instructions through the user interface 20 of the application program, then connects to the cloud platform 1, and purchases and downloads the digital calendar template 200 and the digital creative content 202 provided by the cloud platform 1 (as shown in FIG. 2), The creative terminal. 3 is an intelligent electronic device operated by the creator. The intelligent electronic device receives the instructions input by the creator through the user interface of digital calendar template 200 made by the creator, then connects to the cloud platform 1, and uploads the digital calendar template 200 and digital creative content 202 created by the creator.

To allow creators and the operators of the cloud platform 1 to share profits, a payment platform 5 is further connected between cloud platform 1, each user terminal 2, and each creative terminal 3.

How to purchase the digital calendar template 200 and the digital creative content 202 and pay the related fees, how to purchase the digital calendar template 200 and the digital creative content 202, or how does creative terminal 3 upload the related mechanism of share profits, just like purchasing goods on e-commerce platforms (For example, the paid stickers of software or communication software), so they will not be repeated here.

In the invention, the cloud platform I is connected to user terminal 2 or creative terminal 3 according to the request of user, terminal 2 or creative terminal 3. Furthermore, the user terminal 2.

or the creative terminal 3 uses a built-in application to connect to the cloud platform 1. When the creative terminal 3 is connected to the cloud platform 1, the creative terminal 3 can transmit the digital creative content 202, the digital calendar template 200, or a ci combination thereof to the cloud platform 1. Even the creative terminal 3 can set the price of the digital creative content 202 and the digital calendar template 200 on the cloud platform 1, and the creative terminal 3 can check and confirm the, profit sharing amount on cloud platform 1. The way to price is the same as buying goods on e-commerce platforms, and it will not be described here.

Please refer to FIG. 2, the digital creative content 202 is one of the digital photos, digital images or text, or a combination of an two or more. This digital creative content 202 can be presented according to the presentation defined by the digital calendar template 200, which is combined with the digital calendar schedule.

For example, the digital calendar template 200 further has an image setting area and an event area. The image setting area can combine with the digital creative content 202, and the event area can combine with the digital calendar schedule.

Furthermore as an example, the digital calendar template 200 is a single-month type, and the digital creative content 202 is a digital photo that can be used as the background pattern of the digital calendar template 200. Also, the digital creative content 202 can be a digital image, a type of which is a sticker, and user terminal 2 can fill the sticker into one of the fields of the digital calendar template 200, enriching the graphical digital calendar; in addition, each date of the digital calendar schedule fills in one field of the dates. It should be noted here that the digital calendar template 200 provides days, weeks, months, years, etc., and its appearance is similar to the digital calendar, but the difference between the digital calendar template 200 of the invention and the traditional digital calendar is as described above. The digital creative content 202 can combine with the digital calendar schedule to generate a personalized background pattern, and the digital creative content 202 can be filled in the fields of time, day, week, month, etc., in the digital calendar template. an embodiment, the digital calendar schedule comes from the digital calendar platform 6.

In the invention, the application program of the user terminal 2 can combine with the digital calendar template 200, the digital creative content 202, and the digital calendar schedule to generate the graphical digital calendar, When the user terminal 2 connects and pairs to the display terminal 4, the user terminal 2 transmits the graphical digital calendar to the display terminal 4, and the display terminal 4 outputs to the graphical digital calendar.

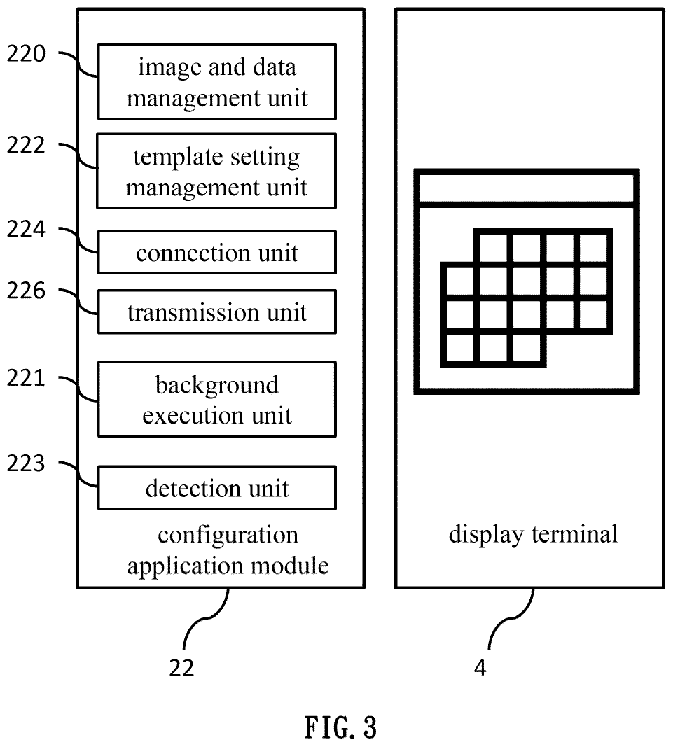

Refer to FIG. 3. In the invention, the user terminal 2 has a configuration application module 22. The configuration application module 22 includes an image and data management unit 220, a template setting management unit 222, a connection unit 224, and a transmission unit 226 The configuration application module 22 is an application program and has a graphical interface to provide various software input objects and screens for displaying the operation of the it and data management unit 220, the template setting management unit 222, the detection unit 223, and the transmission unit 226. The template setting management unit 222 provides the user to set the digital creative content 202 and the digital calendar schedule to be combined with the digital calendar template 200 to generate the display description data of the graphical digital calendar. It is used to provide the subsequent image and data management unit 220 according to the display description data to render and generate a graphical digital calendar. It should be noted here that the template setting management unit 222 sets the digital creative content 202, and the digital calendar schedule to be combined with the digital calendar schedule in the type of the digital calendar template 200. Further, it can be day, week, month, year, etc.; also, different times of a day, different days of a week, different days of a month, or even each year can be preset and combined with different digital creative content 202 into the digital calendar template to generate the display description data of the graphical digital calendar.

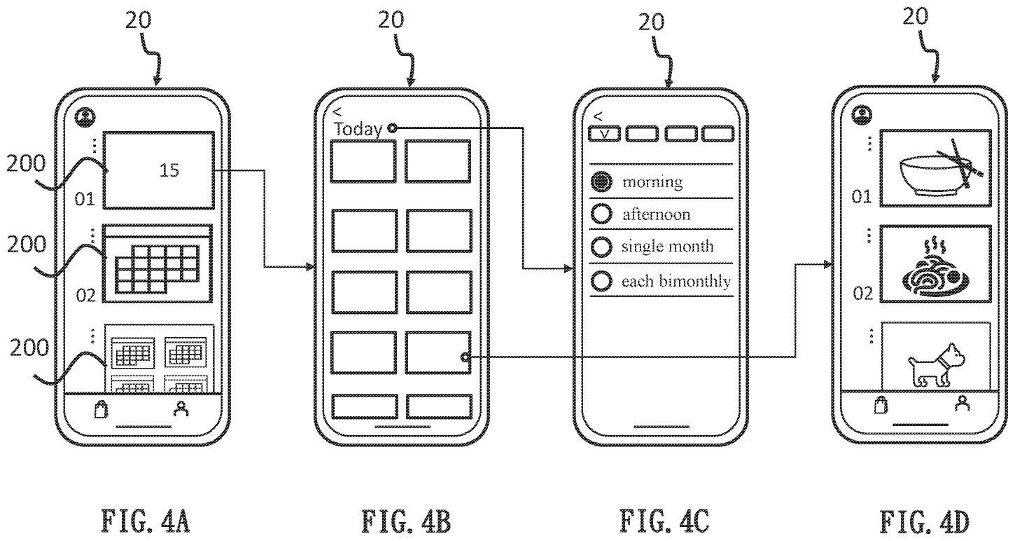

Refer to FIGS. 4A to 4D. For example, user terminal 2 purchases two creative terminals 3 on cloud platform 1 and uploads to different digital creative content 202. The digital creative content 202 is digital photos and is set by the template setting management unit 222 as the digital calendar background for the daily morning and afternoon periods. Or the digital creative content 202 is set by the template setting management unit 222 as the digital calendar background for every single month and each bimonthly. In an embodiment, the digital creative content 202 is a digital calendar template 200 for January, a digital calendar template 200 for February, or the combination thereof, in which the digital calendar templates 200 are combined with at least one of several digital photos, digital graphics, and text.

In the invention, the image and data management unit 220 is further responsible for getting the digital calendar template 200, the digital creative content 202, and the digital calendar schedule, and storing the display description data. The connection unit 224 is responsible for connecting with the display terminal 4. The transmission unit 226 transmits the graphical digital calendar generated by the image and data management unit 220 according to the display description data to the display terminal 4 when the user terminal 2 connects with the display terminal 4 so that the display terminal 4 outputs the graphical digital calendar,

To confirm that the user terminal 2 and the display terminal 4 can be connected, can be reconnected in the future, and can avoid factors such as excessive power consumption, the invention is performed as follows. Refer to FIGS. 1 and 3, the user terminal 2 and the display terminal 4 are connected for the first time, the user terminal 2 uses the connection unit 224 to pair and connect with the display terminal 4, and make the user terminal 2 gets the device serial number and the power information of the display terminal 4. The method is the same or similar to the general Bluetooth wireless transmission. In addition, the user terminal 2 records the current geographic location information, and after the user terminal 2 completes the transmission in the graphical digital calendar, it cut off the connection between the user terminal 2 and the display terminal 4 to avoid consuming power information. Furthermore, the graphical digital calendar is the type of a monthly calendar. The user terminal 2 may have used the configuration application module 22 to set a multi-day graphical digital calendar (as shown in FIGS. 4A to 4D). FIG. 4A shows that the multi-day graphical digital calendar has been set. FIG. 4B indicates that the graphical digital calendar of each day can be previewed, and the user terminal 2 only transmits a part of the graphical digital calendar to display terminal 4. For example, the user terminal 2 only transmits the graphical digital calendar of the current day, tomorrow, and the day after tomorrow to display terminal 4 (as shown in FIG. 4C). FIG. 4D shows the preview photos of the current day, tomorrow, and the day after tomorrow, so that display terminal 4 outputs the corresponding graphical digital calendar according to the current date and time, and when entering the first day of the next month, the display terminal 4 automatically update to the graphical digital calendar to the corresponding month.

The users will update the digital calendar schedule that they use. Therefore, after the user terminal 2 updates the digital calendar every time, the problems of updating the display terminal 4, avoiding the distance between the user terminal 2 and the display terminal 4 is too far away that causing unable to connect, and the connection and transmission continue to cause too much power information consumption need to solve, hi the invention, the user terminal 2 still includes the background execution unit 221 and the detection unit 223. When the background execution unit 221 finds an update event, the transmit unit 226 uses the image and data management unit. 220 to generate a new graphical digital calendar based on the display description data. The update events include but are not limited to adding a schedule to the digital calendar, or the digital calendar does not have a new schedule but needs to be replaced at different times according to the display description data. At this time, the detection unit 223 detects that the display terminal 4 is in the connectable range and state, starts the connection unit 224 to connect the user terminal 2 with the display terminal 4, and then transmits the new graphical digital calendar to the display terminal 4, on the contrary, the user terminal 2 suspends the connection and transmits the new graphical digital calendar to the display terminal 4.

Furthermore, the method that the detection unit 223 confirms the connectable range of the display terminal 4 is that the detection unit 223 detects the current geographic location information (such as a global satellite positioning signal, or called GPS signal) of the user terminal 2, and compares the previously recorded geographic location information with the current geographic location information of user terminal 2 to generate the location distance information. At the same time, the broadcast detection finds the display terminal 4. When the location distance information is less than the preset distance threshold of the detection unit 223, it can be confirmed that the display terminal 4 is in the connectable range. At the same time, the user terminal 2 and display terminal 4 are quite close; to speed up the search for display terminal 4, the frequency of broadcast detection to find display terminal 4 is increased, and the frequency of detection and comparison of the current geographic location information of user terminal 2 is reduced the power information consumption of geographic location information. When the detection unit 223 detects the display terminal 4, it analyzes the signal strength between the user terminal 2 and the display terminal 4, and when the signal strength is greater than. the preset strength threshold of the detection unit 223, the connection unit 224 connects with the display terminal 4 for ensuring the robustness and stability of the connection between the user terminal 2 and the display terminal, and then transfer the new graphical digital calendar to display terminal 4.

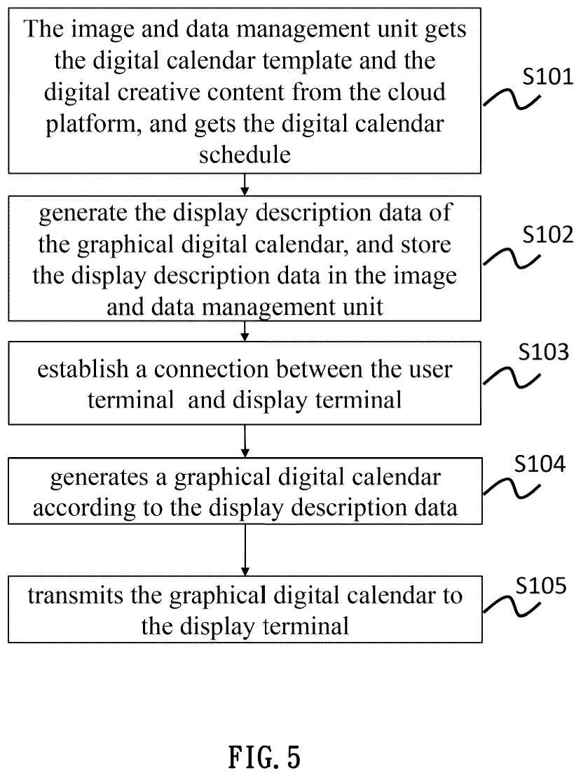

Refer to FIG. 5, the invention is a method for generating a digital calendar, which is applied to the user terminal 2, and the user terminal 2 has a configuration application module 22, which includes an image and data management unit 220, a template setting management unit 222 and a connection unit 224 and the transmission unit 226. It includes the following steps:

(S101) The image and data management unit 220 gets the digital calendar template 200 and the digital creative content 202 from the cloud platform 1, and gets the digital calendar schedule from the digital calendar platform 6;

(S102) The template setting management unit 222 sets the digital creative content 202 and the digital calendar schedule to be combined in the type of the digital calendar template 200 to generate the display description data of the graphical digital calendar, and store the display description data in the image and data management unit 220;

(S103) establish a connection between the user terminal 2 and display terminal 4 by a connection unit 224;

(S104) In the state where the user terminal 2 and the display terminal 4 are connected, the image and data management unit 220 generates a graphical digital calendar according to the display description data;

(S105) The transmission unit 226 transmits the graphical digital calendar to the display terminal 4.

Furthermore, the digital calendar template 200 or digital creative content 202 of the invention is uploaded to the cloud platform 1 by the creative terminal 3. The user pays for the digital creative content 202 or the digital calendar template 200 on the cloud platform 1 by an intelligent electronic device and downloads it to the intelligent electronic device, and creators can share profits with the companies of cloud platform 1.

In the invention, the method of getting the digital calendar schedule by the image and data management unit 220 is that the image and data management unit 220 uses the login information recorded by the user terminal 2 through an application programming interface (API) to log into the digital calendar platform 6 and get the digital calendar schedule. For example, the invention can utilize the application programming interface provided by various digital calendar platforms 6 for the digital calendar schedule.

In the invention, the method of getting the digital creative content 202 and the digital calendar template 200 by the image and data management unit 220 is that the image and data management unit 220 connects with the cloud platform I by a web application programming interface (Web API), and gets the digital creative content 202 and digital calendar template 200 purchased by user terminal 2 from cloud platform 1 The way of purchasing digital creative content 202 and digital calendar template 200 is similar to the process of general e-shopping platforms. For example, it is like purchasing stickers of the LINE communication software or display template. The invention is not limited to this in actual implementation.

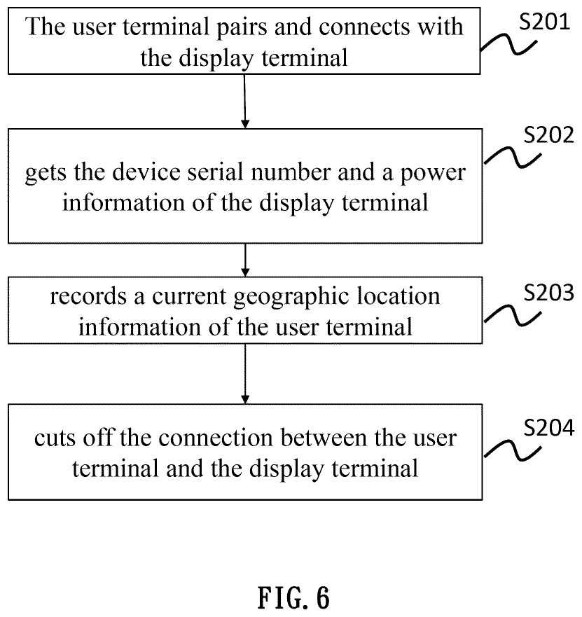

Please refer to FIG. 6, in the invention, when the user terminal 2 and the display terminal 4 are connected for the first time, follow the below steps:

(S201) The user terminal 2 pairs and connects with the display terminal 4 by the connection unit 224;

(S202) When the user terminal 2 pairs and connects to the display terminal 4, the user terminal 2 gets the device serial number and a power information of the display terminal 4, and the purpose of getting the device serial number is to confirm the connection to the previously paired display terminal 4 When reconnecting in the future, and the purpose of getting the power information is to confirm that the display terminal 4 has enough power information to complete the subsequent procedure of passing the graphical digital calendar.

(S203) The user terminal 2 records a current geographic location information of the user terminal, and the current geographic location information is recorded to confirm whether the user terminal 2 is close to the display terminal 4 in the future; the geographic location information is generated by the user terminal 2 can be GPS positioning signal,

(S204) After the user terminal finishes transmitting the graphical digital calendar. The connection unit 224 cuts off the connection between the user terminal 2 and the display terminal 4.

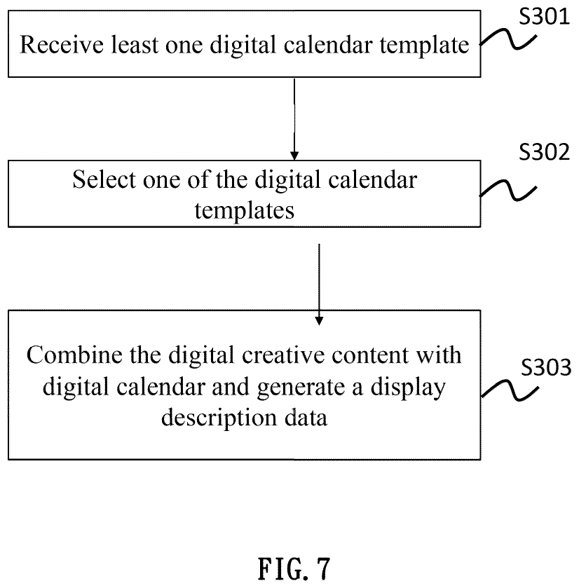

Refer to FIG. 7. In the invention, the step of generating the display description data by the template setting management unit 222 includes:

(S301) Receive one or more combinations of at least one digital calendar template 200 provided by the cloud platform 1. The digital calendar template 200 includes day, week, month, year, etc., and the digital calendar template 200 is similar to the traditional digital calendar template. The difference between the two is that the digital calendar template 200 further has an image setting area and an event area. The image setting area connects with the digital creative content 202, and the event area connects with the digital calendar schedule;

(S302) Select one of the digital calendar templates 200;

(S303) Combine the digital creative content 202 with the image setting area of digital calendar template 200, which is selected. And, combine the digital calendar schedule obtained by the image and data management unit 220 into the event area of the corresponding date in the digital calendar template 200. Then, record them to generate display description data.

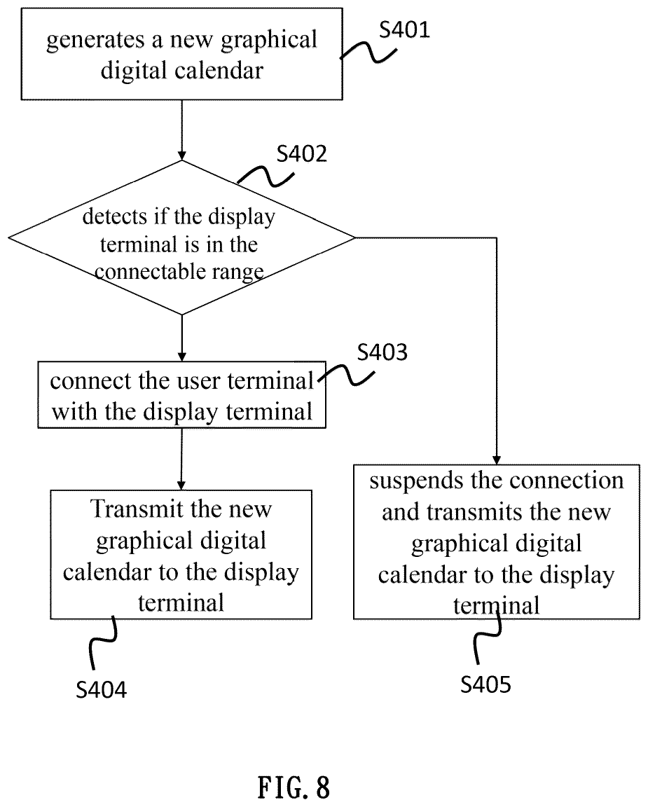

Refer to FIG. 8 in the invention, the user terminal 2 still includes the background execution unit 221 and the detection unit 223. When the background execution unit 221 finds an update event, follow the below steps:

(S401) The image and the data management unit 220 generates a new graphical digital calendar according to the display description data. The update events include but are not limited to adding the digital calendar schedule. Or the digital calendar does not add a new schedule, but needs to be replaced at different times according to the display description data;

(S402) The detection unit 223 detects whether the display terminal 4 is in the connectable range, if so, go to step (S403), otherwise go to step (S405);

(S403) Start the connection unit 224 to connect the user terminal 2 with the display terminal 4;

(S404) Transmit the new graphical digital calendar to the display terminal 4;

(5405) The user terminal 2 suspends the connection and transmits the new graphical digital calendar to the display terminal 4.

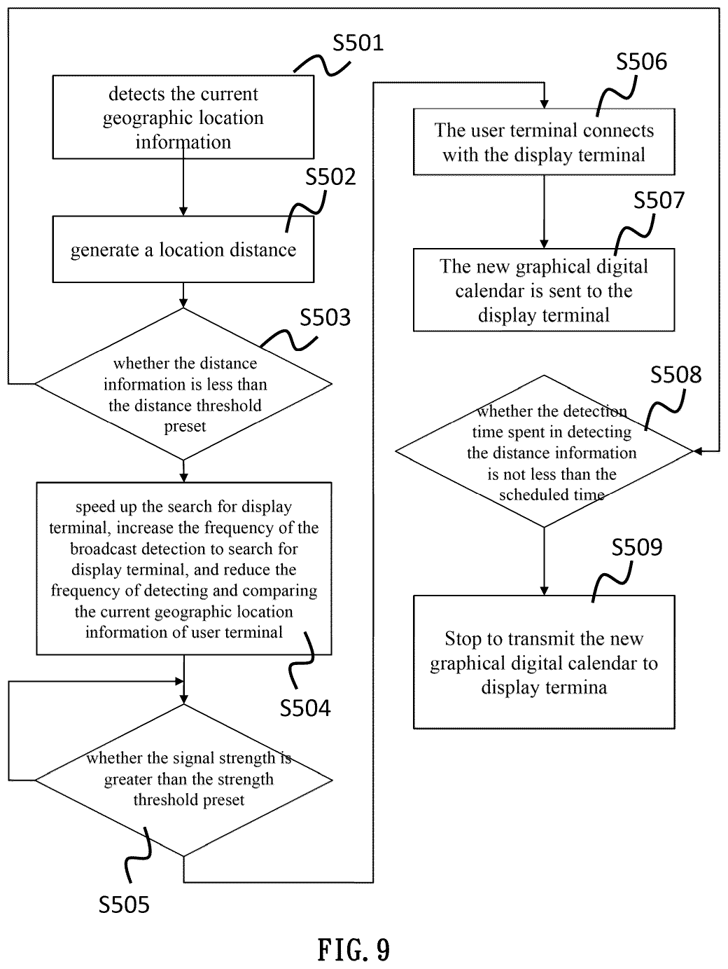

Furthermore, please refer to FIG. 9, the steps for detection unit 223 to confirm that display terminal 4 is in the connectable range include:

(S501) The detection unit 223 detects the current geographic location information (e.g., global satellite positioning signal, or called GPS signal) of the user terminal 2;

(S502) Compares the previously recorded geographic location information with the current geographic location information of the user terminal 2 to generate a location distance. At the same time, the broadcast detection finds the display terminal 4;

(S503) The detection unit 223 confirms whether the distance information is less than the distance threshold preset by the detection unit 223, if so, go to step (S504), otherwise go to step (S509);

(S504) When the distance information is less than the distance threshold, it means that user terminal 2 and display terminal 4 are in the connectable range. At this time the user terminal 2 and the display terminal 4 are quite close. To speed up the search for display terminal 4, the frequency of the broadcast detection to search for display terminal 4 will be increased and the frequency of detecting and comparing the current geographic location information of user terminal 2 will be reduced to reduce the consumption of power information for detecting the geographic location information;

(S505) When the detection unit 223 detects the display terminal 4, it analyzes whether the signal strength between the user terminal 2 and the display terminal 4 is greater than the strength threshold preset by the detection unit 223. If so, go to step (S506), otherwise, go to step (S505);

(S506) The user terminal 2 uses the connection unit 224 to connect with the display terminal 4;

(S507) The new graphical digital calendar is sent to the display terminal 4:

(S508) It is determined whether the detection time spent in detecting the distance information is not less than the scheduled time. If so, go the step (S509), otherwise, go to step (S603);

(S509) Stop to transmit the new graphical digital calendar to display terminal 4.

Furthermore. many computer program products today are mostly application programs for smart devices, and these application programs are listed on the App Store provided by Apple Inc. or downloaded from Google Play provided by Google Inc. Therefore, the invention provides a computer program product for generating a digital calendar. After the computer program product is loaded through an intelligent electronic device, the aforementioned method for generating a digital calendar can be completed.

In summary, the user terminal 2 can use the geographic location information to confirm the relative distance to the display terminal 4. In the state where the distance is close to the display terminal 4, the user terminal 2 connects with the display terminal 4 and transmits the graphical digital calendar to reduce the consumption of power information. The user terminal 2 uses the application to combine the digital calendar template 200 and digital creative content 202 of cloud platform 1 to generate a graphical digital calendar, and further to transmit display terminal 4 to output the graphical digital calendar. It solves the problem that the traditional digital calendar cannot be beautified and cannot be viewed the content of the digital calendar directly.

What is claimed is:

1. An electronic calendar system, comprising:
at least one creative terminal, providing at least one digital creative content and at least one digital calendar template;
a cloud platform, connected with the at least one creative terminal and configured to receive and store the at least one digital creative content and the at least one digital calendar template at least one user terminal, connected with the cloud platform and receiving the at least one digital calendar template and the at least one digital creative content from the cloud platform, wherein the at least one user terminal combines the at least one digital calendar template, the at least one digital creative content, and a digital calendar schedule to generate a graphical electronic calendar; and
at least one display terminal, connected and paired with the at least one user terminal respectively, and receiving the graphical digital calendar through the user terminal that is paired to output the graphical electronic calendar.

2. The electronic calendar system of claim. wherein the user terminal has a configuration application module, and the configuration application module comprises:
an image and data management unit, receiving the digital calendar template, the digital creative content, and the digital calendar schedule and storing a display description data, wherein the image and data management unit generates the graphical digital calendar according to the display description data;
a tern late setting management unit, combing the digital creative content, the digital calendar schedule, and the digital calendar template to generate the display description data for the graphical digital calendar;
a connection unit, configured to connect with e display terminal; and
a transmission unit, transmitting the graphical digital calendar to the display terminal for outputting the graphical digital calendar when the user terminal is connected with the display terminal.

3. The electronic calendar system of claim 2, wherein when the user terminal is connected with the display terminal for the first time, the user terminal is paired and connected with the display terminal through the connection unit, obtaining a device serial number and a power information of the display terminal, recording a current geographic location information, and after the graphical electronic calendar is transmited, disconnecting from the display terminal.

4. The electronic calendar system of claim 2, wherein the user terminal further comprises:
a background execution unit, controlling the image and data management unit to generate a new graphical digital calendar according to the display description data when an update event occurs;
a detection unit, wherein when the detection unit detects that the display terminal is in a connectable range and state, the detection unit activates the connection unit to establish a connection between the user terminal and the display terminal and then transmit the new graphical digital calendar to the display terminal.

5. The electronic calendar system of claim 4, wherein the detection unit detects a current geographic location information of the user terminal and generates a position distance information by comparing a previously recorded geographic location information and the current geographic location information;
at the same time, the detection unit performs a broadcast detection to search the display terminal, and when the position distance information is less than a preset distance threshold of the detection unit, the detection unit increases a frequency of broadcast detection and reduces a frequency of detecting and comparing the current geographic location information of the user terminal;
when the detection unit detects the display terminal, the detection unit analyzes a signal strength between the user terminal and the display terminal;
when the signal strength is greater than a preset intensity threshold of the detection unit, the detection unit makes the connection unit connect with the display terminal, and then transmits the new graphical digital calendar to the display terminal,

6. A method for generating a digital calendar, applied at a user terminal, wherein the user terminal has a configuration application module, and the configuration application module comprises an image and data management unit, a template setting management unit, a connection unit, and a. transmission unit, comprising the following steps:
obtaining a digital calendar template, a digital creative content, and a digital calendar schedule from a cloud platform by the image to and data management unit;
by the template setting management unit, setting a type of the digital creative content and the digital calendar schedule combined in the digital calendar template to generate a display description data of a graphical digital calendar, and storing the display description data in the image and data management unit; and
establishing a connection between the user terminal and the display terminal by the connection unit, and when the user terminal is connected with the display terminal, transmitting the graphical electronic calendar to the display terminal by the transmission unit, wherein the graphical electronic calendar is generated by the image and data management unit according to the display description data.

7. The method of claim 6, wherein when the user terminal is connected with the display terminal for the first time, following the below steps:
paring and establishing the connection between the user terminal and the display terminal by the connection unit, and after the user terminal is connected with the display terminal, obtaining a device serial number and a power information of the display terminal by the user terminal; and
disconnecting the connection between the user terminal and the display terminal after the graphical digital calendar is transmitted.

8. The method of claim 6, wherein the step of generating the display description data of the graphical digital calendar by the template setting management unit comprises:
providing the digital calendar template having the type, wherein the type comprises at least one information of day, week, month, and year:
selecting, the digital calendar template, and combining the digital creative content into an image setting area of the digital calendar template that is selected; and
by the image and data management unit, combining the digital calendar schedule into an event area of a corresponding date in the digital calendar template to generate the display description data.

9. The method of claim 6, wherein the user terminal further comprises a background execution unit and a detection unit, and when the background execution unit finds an update event, the method further comprises steps:
generating a new graphical digital calendar according to the display description data by the image and data management unit;
detecting whether the display terminal is within a connectable range by the detection unit;
when the display terminal is within the connectable range, activating the connection unit to establish a connection between the user terminal and the display terminal; and
transmitting the new graphical digital calendar to the display terminal by the transmission unit.

10. A computer program product for generating a digital calendar, after the program product is loaded through an intelligent electronic device, the method of claim 6 is executed.

11. The computer program product for generating a digital calendar of claim 10, wherein when the user terminal is connected with the display terminal for the first time, following the below steps:
paring and establishing the connection between the user terminal and the display terminal by the connection unit, and after the user terminal is connected with the display terminal, obtaining a device serial number and a power information of the display terminal by the user terminal; and
disconnecting the connection between the user terminal and the display terminal after the graphical digital calendar is transmitted.

12. The computer program product for generating a digital calendar of claim 10, wherein the step of generating the display description data of the graphical digital calendar by the template setting management unit comprises:
providing the digital calendar template having the type, wherein the type comprises at least one information of day, week, month, and year;
selecting the digital calendar template, and combining the digital creative content into an image setting area of the digital calendar template that is selected; and
by the image and data management unit, combining the digital calendar schedule into an event area of a corresponding date in the digital calendar template to generate the display description data.

13. The computer program product for generating a digital calendar of claim 10, wherein the user terminal further comprises a background execution unit and a detection unit, when the background execution unit finds any update event, following the below steps:
generating a new graphical digital calendar according to the display description data by the image and data management unit;
detecting whether the display terminal is within a connectable range by the detection unit;
when the display terminal is within the connectable range, activating the connection unit to establish a connection between the user terminal and the display terminal; and
transmitting the new graphical digital calendar to the display terminal by the transmission unit.
